(19) United States
(12) Patent Application Publication
(10) Pub. No.: US 2002/0133699 A1
(43) Pub. Date: Sep. 19, 2002

(54) Method and apparatus to regulate use of freely exchanged files and streams

(76) Inventor: Roy Myron Pueschel, Duxbury, MA (US)

Correspondence Address: ROY M. PUESCHEL, 16 OCEAN AVE., DUXBURY, MA, 02332, US

(21) Appl. No.: 09/681,279

(22) Filed: Mar. 13, 2001

(51) Int. Cl. H04L 9/00

(52) U.S. Cl. 713/153

(57) ABSTRACT

A method and apparatus is provided for regulating the use of freely distributed files and streams comprising the installation of one or more local software nodes associated with one or more encrypted credit objects and one or more encrypted policy objects which are used to regulate use of files and streams according to credit policies. This method and apparatus provides the ability to implement a credit policy. Further, this credit policy can be implemented or modified without requiring a new version of the associated product. This present invention also provides the ability to securely create and modify encrypted credit objects, while still permitting the free exchange and transfer of files and streams.

### BACKGROUND OF THE INVENTION

The recent development of networking exchange of music files and video files has created a problem with regulation of the exchange. There is no practical method in place to regulate use of these files. This has created serious legal problems for the expansion of web server and peer-to-peer distribution technologies. One example of this need relates to publishing of music files. This invention allows for music authors and publishers to provide free access to their files and streams, through peer to peer publishing as well as through any other means, while still maintaining localized control as permitted by the originators of the files and streams. The difficulty of controlling encrypted information locally is that it presents the problem that a computer hacker could possibly determine the encoding scheme and develop a piece of software to violate the security. This present invention makes this practically impossible by using a complex local node. The complexity and variety of the nodes, requiring a custom installation program for each node delivers a good level of security. Furthermore, this present invention provides a method for the node to be updated, resulting in changed characteristics, and improved security. This present invention furthermore employs the concept of software channels that securely deliver data to be used by the associated application. These channels are memory locations and other exchange locations within the local computer used to securely transfer data from the node to the selected application. The locations used change dynamically by algorithm and based upon keys provided from the local node.

This invention additionally provides the advantage that many streamed sources of data can be securely stored on a local computer while still enforcing policy control over the stream or file. The result is improved quality of the stream by buffering. This also permits access to the stream even while disconnected from the network.

The following example is a typical scenario of this present invention. This example is one of many possible scenarios of this present invention and in no way restricts this invention from other scenarios. It is presented to provide illustration of typical operation. This in no way restricts this present invention from all applications and scenarios that apply, but is added only for the purpose of illustration only.

1. A user connects to a secure source of credit objects over a network via computer.

2. This same user negotiates to obtain a credit object online for a particular source of files or streams, and the encrypted credit object is transmitted to the local computer. Generally, some form of payment is made for the object via secure connection.

3. In the case of files and streams that require a player or viewing software, the user must load and install a current version of player or viewing software on the local computer, if the player or viewer is not loaded or installed already. Likewise, the user must already have loaded and installed the node described in this present invention and also the policy object for the associated file or stream to view or play. The user must also either receive or load the stream or file to play or view. This may be done over the network.

4. The user must also either receive or load the stream or file to play or view. This may be done over the network.

5. When the user selects to play or view the stream or file with a player or viewer, this present invention performs the following operations:

If the associated secret key required to decrypt the file or stream is not found, it is then obtained over the network by contacting the controlling authority for the file or stream.

The policy object associated with the file or stream selected is decrypted using a public-key to determine policy for the file or stream.

Credit is verified to determine that there is sufficient credit by decrypting the credit object using an associated secret encryption key contained within the node.

The amount of credit is adjusted per the policy by the node.

The credit object is re-encrypted by the node using it's secret encryption key.

The file or stream is decrypted in part as it is played or viewed with the associated software.

It is another objective of this present invention to identify a file or stream and the associated policy and credit object. This is done with encrypted headers for identification. The file or stream has an encrypted header, which is decrypted. This header contains the information necessary to identify the associated policy and credit object. The files and streams may be entirely encrypted or only partially encrypted, provided the encryption is sufficient to insure that the file or stream is unusable or of greatly reduced quality without decryption. The purpose of partial or intermittent decryption is to reduce the amount of processing required to decrypt the file or stream. This provides improved performance on the local computer.

It is furthermore an objective of this present invention to provide encrypted credit objects that identify the credit for a given file or stream. The credit objects are encrypted with a secret key, which is available only to the local node on a computer and to the node originator. A controlling authority that generates credit objects for files and streams obtains a secret key for an individual node from the node source. This secret key is used to encrypt either the credit object or an associated secret key or both. The controlling authority may optionally generate a unique associated secret key for a credit object. This is not required by the present invention, but is the preferred method. If the unique associated secret key is generated along with the credit object, then the credit object is encrypted with the unique associated secret key, and the unique associated secret key is, in turn, encrypted with the secret key owned by the local node of the target computer. The credit object is used to keep track of the amount of credit that is available on a local computer for associated files or streams. The credit object contains data that associates it with a file, stream or group of files or streams. It also contains credit amount. The local node uses policy rules contained in the associated policy object to adjust the credit amount.

It is yet another objective of this present invention to provide encrypted policy objects which identify the rules for a given file or stream, or group of files or streams. A controlling authority is the source of the policy object for a file, stream or group of files or streams. The local node uses the associated policy object to determine specific rules governing the local use of a file, stream or group of files or streams. The policy object is encrypted with public-private key encryption, or it may be contained within the credit object described in the above objective. If the policy object is separated from the credit object, it may be updated separately. This would improve security, but the separation of the policy object from the credit object is not a requirement of this present invention. It may be contained as part of the credit object or it may be separate, which is the preferred method.

It is another objective of this present invention to provide localized unique nodes that are generated by a node originator. The node originator creates a node that is unique in structure from most other nodes that are created. The greater the uniqueness, the better the security. This present invention allows for the node to have completely unique structure, but this is not a requirement. The local node has at least one secret key. This key is distributed within the node in such a complex and varied way that it remains secure even on the local computer. One or more nodes may be installed on a local computer, but it is the preferred method of this invention to have only one node installed on a local computer.

The node complexity and variety is such that it requires an installation program to install the node on the local computer. This installation program can be transmitted along with the node itself, and may be part of the node software itself, such that it installs itself on the computer. The installation program may also be transmitted separately. The preferred method is to transmit the installation program along with the node, which immediately installs it as it is received.

This invention additionally provides the advantage that many streamed sources of data can be securely stored on a local computer while still enforcing policy control over the stream or file. The result is improved quality of the stream by buffering. This also permits access to the stream even while disconnected from the network.

### SUMMARY OF INVENTION

It is one objective of this present invention to permit free distribution of files and streams while still maintaining legal control of said files and streams. This is accomplished by the combined operation of the following objects:

1. Encrypted, partially encrypted or intermittently encrypted files or streams and their associated secret public keys to allow for decryption by the local node.

2. Encrypted policy objects that are used to determine policy. Policies describe the current rules applying to a particular file, stream or group of files or streams. A controlling authority sets these rules. The controlling authority as policies change may update them. The encrypted policy object may be contained within an encrypted credit object for convenience. The encrypted policy object may also be separate from an encrypted credit object. The encrypted policy object uses simple public-private key encryption.

3. Encrypted credit objects along with the associated secret public keys. The encrypted credit objects contain the credit available for an associated file, stream or group of files or streams. The local node decrypts these credit objects when a file or stream is selected for use. The credit object is adjusted and re-encrypted. The credit object is associated with an encrypted secret key, which is decrypted when loaded into the node.

4. A unique local node so complex that it prevents access to secret keys within the node, providing external control over these encrypted objects. The complexity and variety of the node provides both uniqueness and security of the decrypted secret keys.

5. A unique node installation program which installs said node on the local computer.

6. Channels, which dynamically change while sending data to the software application that uses the data . These channels may also be used to securely send data from the application to the hardware used to produce either video or audio within the computer. The channels are several memory locations used to transfer data according to key and algorithmic selection determined by the local node. They help to prevent unauthorized interception of data within the local computer.

It is another objective of this present invention to allow for optional network connectivity. This is not required for this present invention, but is the preferred method. The node can use its network connectivity to initiate periodic contact with the node originator to verify the state of the node. The node originator sets the frequency that is required for verification. Node verification provides improved security, but is not required for this present invention.

### BRIEF DESCRIPTION OF DRAWINGS

FIG. 1: An Individual Computer This pictorial depiction shows an example of computer hardware such as would run the software described in this present invention.

FIG. 2: Computer Networks and Interconnection. This is a schematic of various computers that can interconnected via Local, Wide Area Networks and the Internet. This present invention applies to many types of computer hardware.

FIG. 3: Preferred Use Flow Diagram. This flow diagram identifies the preferred flow, which includes receiving a file or stream and then both storing it to disk and selecting and using the file or stream after saving it locally.

FIG. 4: Check Credit and Policy Use. This flow diagram shows the flow of operation on a credit object and on a policy object within the local computer.

FIG. 5: Connect To Application, Decrypt And Use. This flow diagram shows the method of validating the application and then decrypting portions of the file or stream and delivering those to the application for use.

FIG. 6: Validate Application and Connect. This flow diagram describes the method for secure application validation and connection from the node.

FIG. 7: Deliver Data to Application. This flow diagram shows the flow of delivery of data to the application from the local node.

FIG. 8: Credit Object Encryption. This flow diagram describes generation of credit objects from a source.

FIG. 9: File and Stream Encryption. This shows the flow for encrypting a file or stream.

FIG. 10: Secure Node Processing. This shows the technique used within the node to maintain a hidden secret key to insure security.

FIG. 11: Node Complexity. This diagram shows an example of directory structures and other storage locations used to maintain node security.

FIG. 12: Node Generation Flow. This flow diagram shows the method of generating a node at the source.

FIG. 13: Node Installation Flow. This diagram shows the flow of installing a node on a local computer.

FIG. 14: Node Update Flow. This flow diagram shows the method of updating a node in use.

FIG. 15: Intermittent Encrypted File or Stream. This diagram shows an intermittently encrypted file or stream, if used.

FIG. 16: Policy Update Flow. This flow diagram shows the method used to update policy.

FIG. 17: Policy Object Encryption. This diagram shows the method used to encrypt policy objects.

FIG. 18: Application to Firmware/Hardware Connection Diagram. This diagram shows interconnection from the application to hardware/firmware using channels.

### DETAILED DESCRIPTION

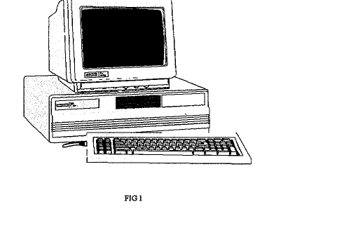

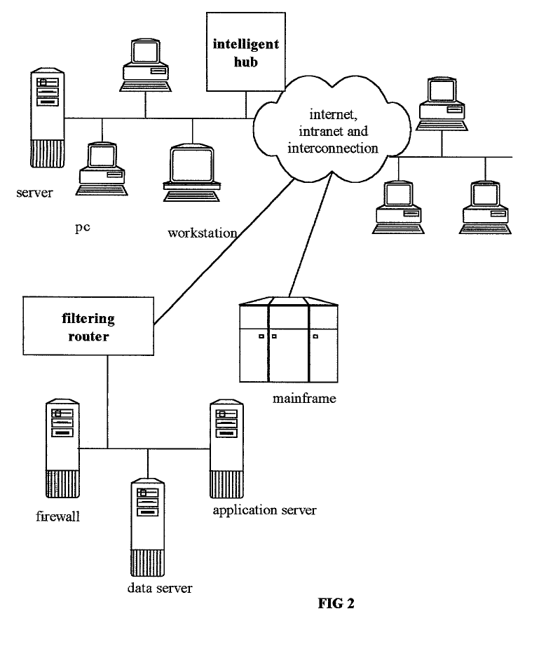

FIG. 1: Individual Computer. This pictorial representation of an individual computer applies to any and all computers having processor control. As mentioned below in FIG. 2, computers include mainframe, mini-computers, personal computers, laptop computers, notebook computers, palmtop computers and others. This present invention applies to any electronics equipment, which has a processor, and some means of data transfer, and particularly as applied to the Internet and network for file and stream transfer. This present invention allows standalone computers to use files and streams while still maintaining authorized control of use, even when disconnected from a network.

FIG. 2: Computer Networks and Interconnection. This is a schematic of hardware that may be interconnected via Local, Wide Area Networks and the Internet. All of the hardware computers shown, including servers and personal computers of all kinds can be used with this present invention. This also includes notebook computers, and small handheld computers, sometimes referred to as palmtops. Connection to the Internet or any network can be through any conventional hardware connection such as T1, DSL, cable modem or telephone modem. Additionally, local interconnections may use Ethernet cable, infrared, RS232 cable interconnection, parallel cable interconnection, SCSI and others. As mentioned in FIG. 1, this present invention allows use of files and streams while disconnected, however, it is the preferred method to operate the computer connected to a network as much as possible.

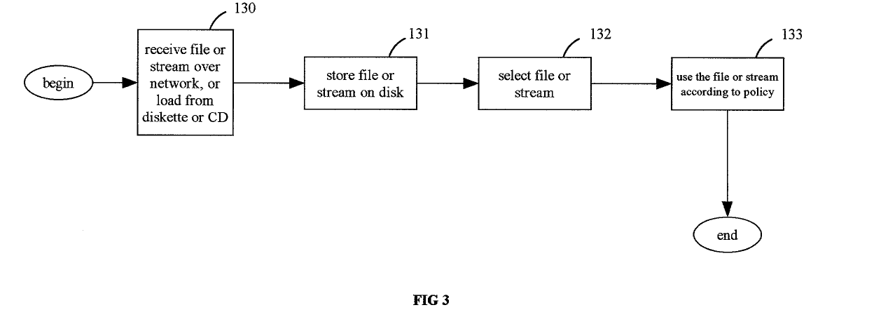

FIG. 3: Preferred Use Flow Diagram. This flow diagram shows the following preferred flow, which includes receiving a file or stream and then both storing it to disk and selecting and using the file or stream after saving it locally:

Flow begins with Block 130. A file or stream is received over the network. Typically, this is done by a peer-to-peer transfer over the Internet, but may be a network transfer of any kind. It may also be performed as a download from a server, or as a copy of some transfer media such as a floppy diskette or CD.

Next, block 131 in the flow, the file or stream is stored to local storage of the computer in use. This is not a requirement of this present invention, but is the preferred method of operation. The file or stream may be used as a transient object, never storing to persistent storage of the computer.

Following this, the flow is block 132 that describes the selection of a file or stream for use. A file or stream is selected either from local storage, or over the network. Local storage and selection of the file or stream on the local computer is the preferred method for use with this present invention.

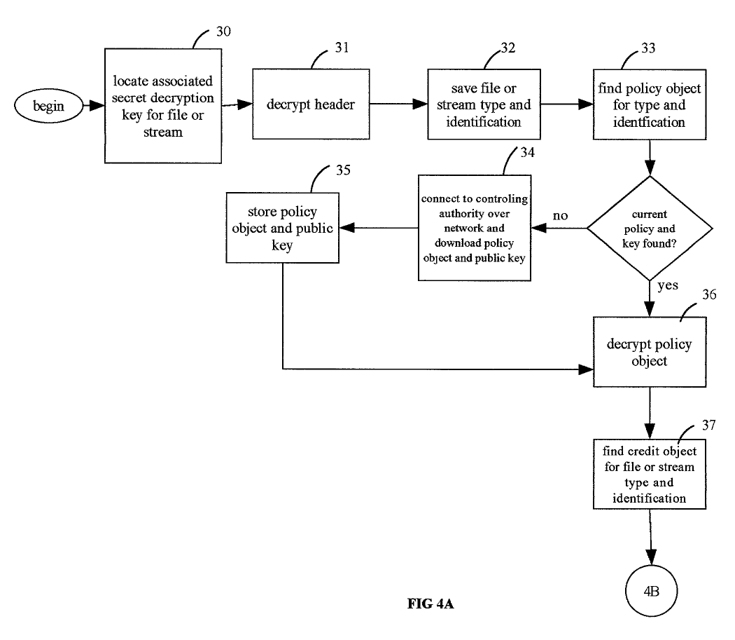

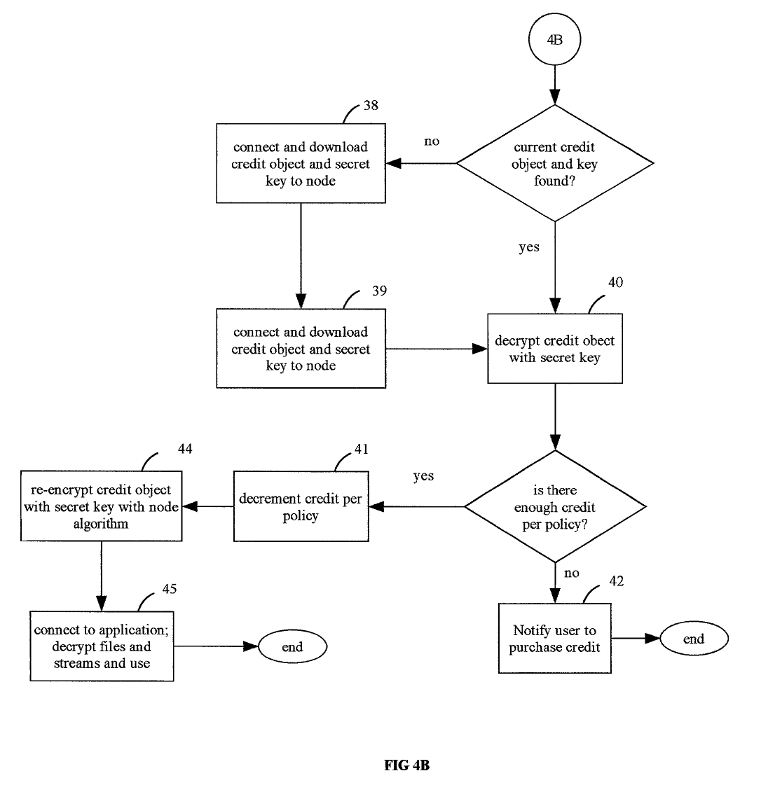

The final block in this flow, block 133 shows use of the policy or stream according to policy. This block is further decomposed by the flow in FIG. 4.

FIG. 4: Use File or Stream according to Policy. This flow describes the following method of this present invention for use of file or stream:

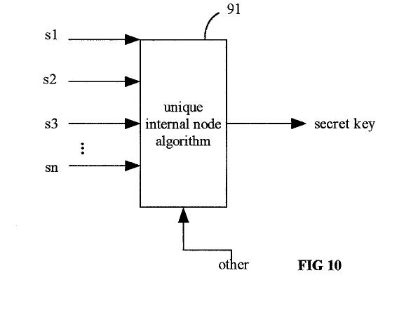

First (block 30), the associated secret decryption key is reconstructed in the node, as is done with all secret keys owned by the node (see FIG. 10). Following this, the header of the file or stream is decrypted in block 31. This is performed in the local node. Next the type and identification for the file or stream is saved within the local node, block 32.

Next, block 33, the corresponding policy object for file or stream type and identification are located.

If a corresponding policy and key are not found or not current, then the local node connects to the controlling authority and downloads a current policy object, as shown in block 34. A table of controlling authorities is either retained in the computer or acquired through network connection.

The new policy object and public key are stored on the local computer by the node in their encrypted form as shown in block 35. This present invention requires that all operations performed with regard to the node are unique and varied per installation and updates, providing secure operation on the local computer.

Next, the policy object is decrypted within the node. Following this, the credit object and key corresponding to file or stream is located. If the credit object and key are not found, then the node connects and downloads a credit object and secret key from the controlling authority, as shown in block 39.

Following this, the credit object is decrypted within the node, block 40. If there is not enough credit to use the file or stream per the policy, then the user of the computer is notified to purchase credit, block 42. This is done via network connection.

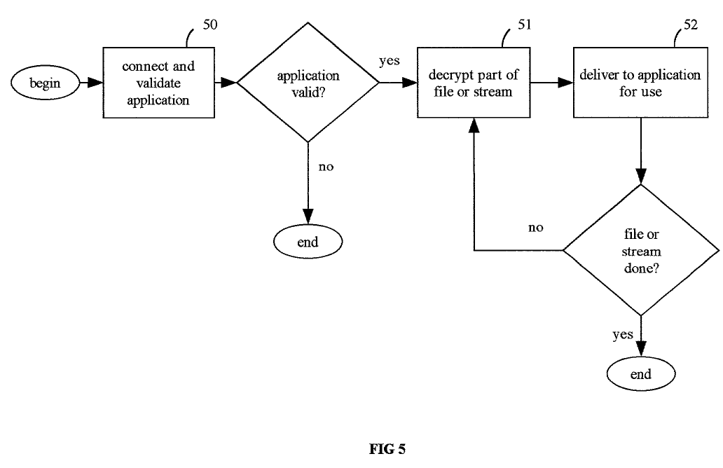

If sufficient credit exists, the credit is decremented per policy in block 41. The credit object and secret key are re-encrypted within the node in block 44. Finally in block 45, the application is connected and the selected file or stream is delivered for use (see FIG. 5).

FIG. 5: Use File or Stream. The application is validated, and the file or stream is decrypted as it is fed to the application. This figure shows the following flow of using a file or stream:

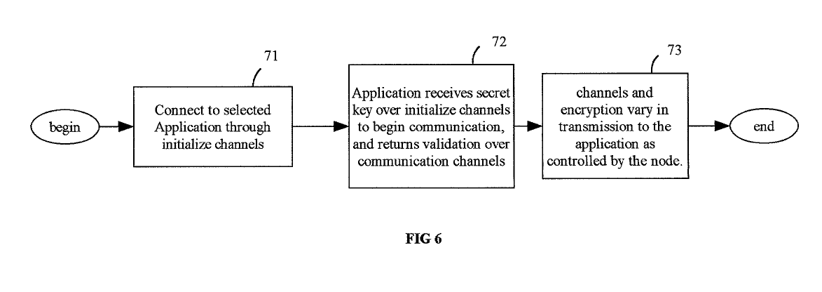

First, the selected application is verified to determine if it is current and valid, block 50. See FIG. 6. If the application is not current or valid, a new one must be downloaded or obtained through installation, all of these methods fall within the scope of this present invention.

The selected file or stream is then partially decrypted and delivered to the application by the node. These are shown in blocks 51 and 52. Delivery is through secure channels that are described in FIG. 6.

FIG. 6: Connect and Validate Application. The local node makes use of channels for connection. These channels are software means of connecting to the application. These can be memory locations, sockets, ports or any other connection means. The node uses any available means and connects through them, even sending false data to unused channels. This figure shows the following flow for connecting and validating an application by said node:

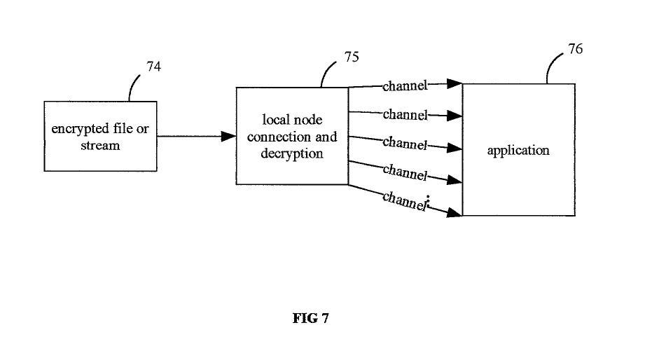

Connection is made in block 71 through pre-established channels. The initial connection is made through these, and these are re-assigned as the application is updated. The node securely encrypts and saves these channels, and establishes connection by passing a generated encrypted key through them, and receives a response back through channels identified by the encrypted key, which is internally decrypted by the application. Again, false data is presented on unused channels. The channels used are dynamically changed as data is sent to the application. New keys are sent, which describe new channel patterns. This process is described in block 72. A diagram of the channels is shown in FIG. 7.

The application itself, which makes use of the file or stream, may also use channels to connect to the hardware and firmware that is used to process the file or stream into video or audio or both. As with the application, firmware that runs the hardware may also be updated periodically for better security. This method improves security of the system, and is the preferred method of this invention, but is not a requirement.

FIG. 7: Deliver Data to Application. This process diagram shows the following method used to deliver the data to the application through local node decryption and complex delivery used to maintain security:

The process of data delivery to the application begins with the selected encrypted file or stream in block 74.

This is followed by decryption of the file or steam within the node, as described in block 75 (see FIG. 5).

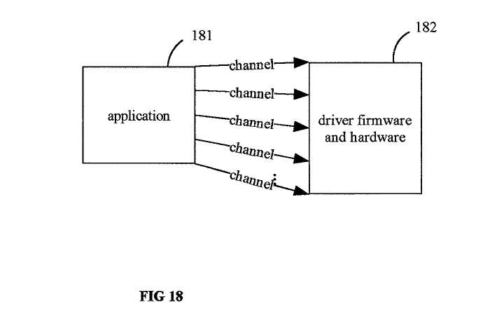

Decrypted data is passed through the channels shown, which are various memory locations, ports, and other means of connection within the computer. These are shown interconnecting block 75 and 76. Block 76 is the application itself. Note that the application may also use varying channels and encryption in connecting to the hardware. See FIG. 18. Use of channels is the preferred method for this present invention, but is not a requirement.

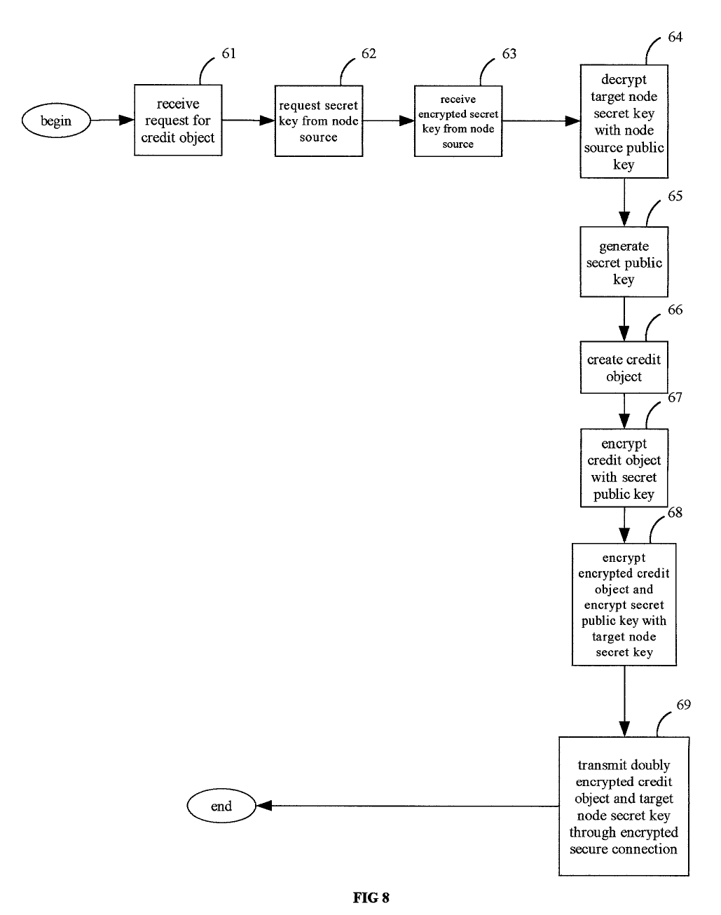

FIG. 8: Credit Object Encryption. This diagram describes the following flow of generating of credit objects for a requestor:

This flow begins with a request for a credit object as shown in block 61. This request is made to a controlling authority for an associated file, stream or group of files or streams. The node-making request sets up a connection and arranges for payment or agreement of some form, as required by the controlling authority. The node provides identification in the form of a secret encrypted identification key.

The controlling authority, then, requests the secret key from node source, passing along the secret public encrypted identification key that is received with the request (block 62). This is the preferred method that provides best security. An alternative method is to use the secret encrypted identification key to encrypt the generated credit object and it's secret key. This then would not require the controlling authority to contact the node source to obtain the secret key for the target node.

Next, the controlling authority receives encrypted secret key from node source over a secure connection, such as SSL or other such means of transmission (block 63). This is the preferred method, but a secure connection is not required.

The controlling authority then uses the current node public key to decrypt the encrypted target node secret key (block 64). This is the preferred method to be used for improved security, but is not required.

The controlling authority then generates secret a public key for the target node (block 65).

A credit object is created for the target node (block 66). The order of block 65 and 66 is unimportant, block 66 may precede block 65. The credit object is encrypted with the generated secret public key (block 67).

The encrypted credit object and the secret public key are then both encrypted with the target node secret key, which was obtained from the node source. This is the preferred method providing optimum security. Alternatively, the secret key received from the target node can be used to encrypt the encrypted credit object and secret public key (block 68).

The controlling authority then transmits the resultant encrypted credit object and secret key, through some secure connection such as SSL or other such means of transmission. This is the preferred method, but a secure connection is not required.

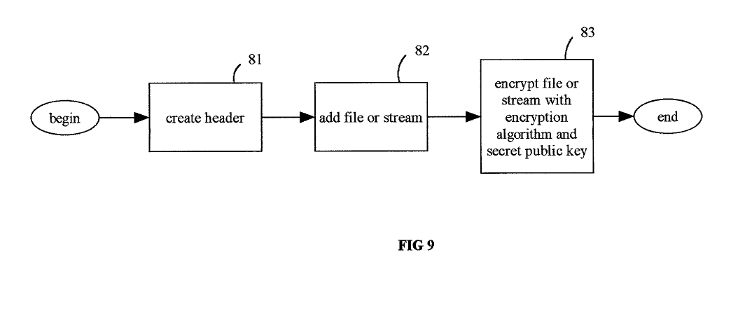

FIG. 9: File and Stream Encryption. This figure shows the following flow for encrypting a file or stream:

First, the header is created (block 81). The header contains necessary file or stream identification.

Next, the data from the file or stream is added to the header (block 82). Finally, the file or stream is encrypted with an encryption algorithm and secret public key.

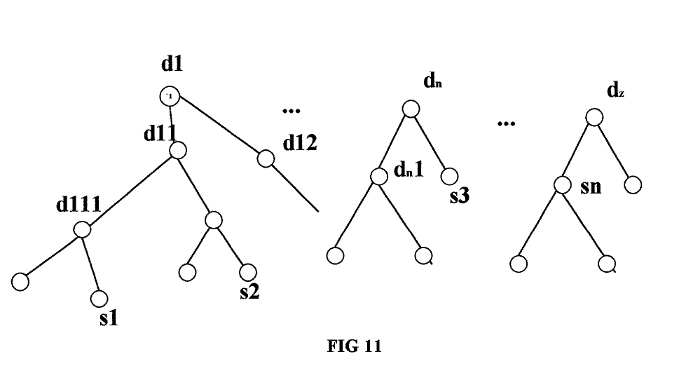

FIG. 10: Secure Node Processing. This figure shows the technique used within the node to maintain a hidden secret key to insure security. Block 91 identifies unique internal node algorithm. Note that the sources described as “s1” through “sn” are identified in FIG. 11 that describes the node complexity. This is a novel aspect to this invention that makes use of complexity within the local computer to provide local security. The node algorithm makes use of various complex sources to compose the secret key. The algorithm itself may be modified periodically during node update. This is the preferred method, but is not a requirement for this present invention. Other data may also be used in formation of the secret key. This data may be obtained from any characteristics of the local computer. This additional data is not a requirement for this present invention, but may provide additional security.

FIG. 11: Node Complexity. This diagram shows an example of directory structures and other storage locations used for distributing the hidden keys within the local computer by the node. Local nodes determine complex data access structures. One example of such a data access structure is a directory structures within an operating system, but data access structures are not restricted to such structures. The novelty of this present invention involves the complexity and also the capability to update and change the structure characteristics periodically.

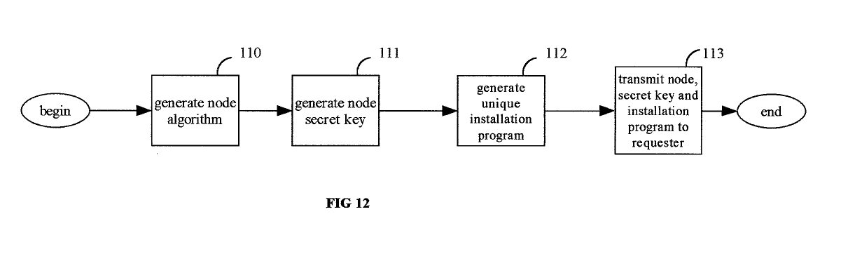

FIG. 12: Node Generation Flow. This flow diagram describes the following method of generating a node by the node source:

First the node source generates a unique node algorithm (block 110). This is the preferred method for this present invention, but is not a requirement. Secondly, the node source generates a node secret key (block 111). This node secret key is used to secretly decrypt data on the local computer.

Next, the node source generates a unique installation program. This program requires connection to the node source during installation (block 112).

Finally, the node source transmits the node, secret key and installation program to requester through a secure connection. The secure transmission is not required for this invention, but is preferred (block 113).

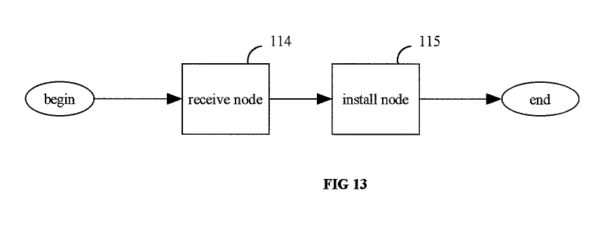

FIG. 13: Node Installation Flow. This diagram shows the following flow of installing a node on a local computer:

The local computer receives the node, secret key and installation program, preferable through a secure connection (block 114). The secure connection is the preferred method, but is not a requirement.

The installation software then installs the complex local node on the local computer (block 115). The installation program requires network connection to the node source to obtain installation data during installation. Likewise, the installation program transmits integrity information to the node source to verify security and integrity of the installation.

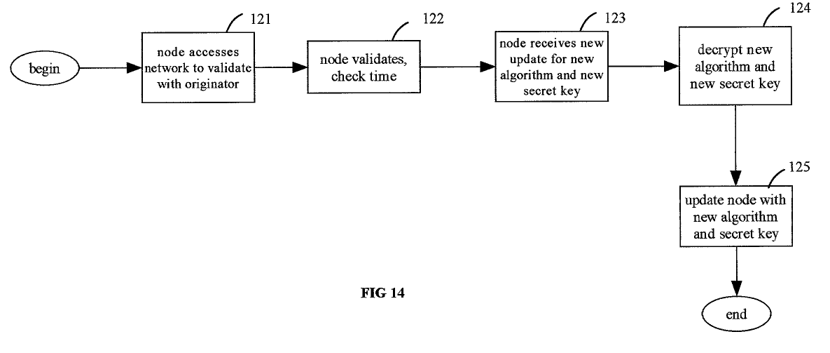

Installation data, as with update data described in FIG. 14 may include data such as time verification, or may be unique randomly generated data used in node unique identification also described in FIG. 14. Use of such data is the preferred method of this present invention, but is not required.

FIG. 14: Node Update Flow. This figure describes the preferred method of updating the local node to provide improved security. This method is preferred, but is not required by this present invention. This flow diagram shows the following method of updating a node in use:

The node accesses the network to validate with originator (block 121).

The node validates and verifies time settings with the node source (block 122). Time verification is not required, but is the preferred method for this present invention.

The node then receives new algorithm and new secret key (block 123).

The node decrypts the new algorithm and new secret key (block 124).

Finally the node updates itself with the new algorithm and secret key (block 125).

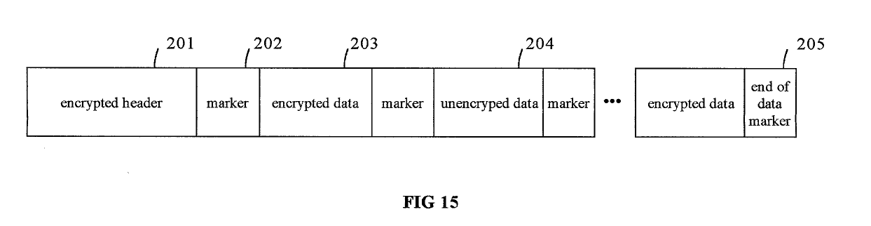

FIG. 15: Intermittent Encrypted File or Stream. This diagram shows an intermittently encrypted file or stream. The advantage of intermittent encryption, or even partial encryption is that less processor effort is required in the decryption of the file or stream. This method is the preferred method for this present invention, but is not required. The entire file or stream may be encrypted, or partially encrypted.

The first block (201) shows the encrypted header. This header contains identification information for the file or stream.

The second block (202) shows the marker, which may be used. Alternatively, the header may be a fixed length, or may contain length information itself.

The marker is not a requirement of this present invention.

The third block (203) shows encrypted data.

The fourth block (204) shows a section of unencrypted data, this may or may not be used, as mentioned above. If used, it also may or may not be ended with a marker before beginning another section of encrypted data. Lengths of segments may also either be fixer or contained in the header of the file or stream.

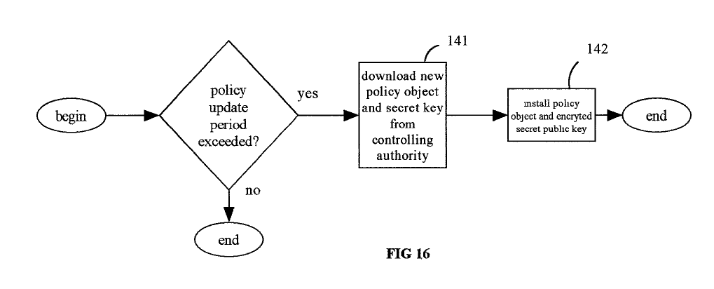

FIG. 16: Policy Update Flow. This method is not required for this present invention, but is the preferred method since it provides improved security. This diagram describes the following flow for policy update:

First the local node determines if the policy update period has been exceeded. This may be determined by the node keeping track of time, or number of uses.

Secondly, (block 141) the local node downloads a new policy object and secret key from its controlling authority, or from another authorized source.

Finally (block 142), the node installs said policy object and encrypted secret public key in the local computer.

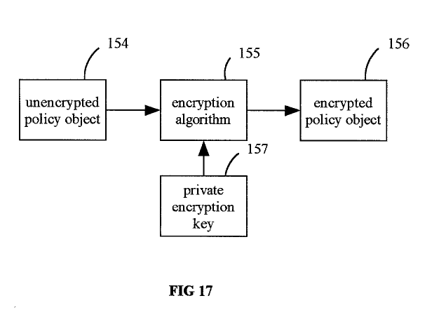

FIG. 17: Policy Object Encryption. This is a block diagram of a routine for encrypting policy objects.

The unencrypted policy object (block 154) is provided as an input to the encryption algorithm (block 155).

The private encryption key (block 157) is utilized as an encryption key in the encryption algorithm (block 155).

The output of encryption algorithm (block 155) is an encrypted policy object (block 156).

The encryption algorithm (block 155) may use any form of algorithm, such as DES, elliptic curve; etc.

FIG. 18: Application to Firmware/Hardware Connection Diagram. This diagram shows interconnection from the application to hardware/firmware using channels. Data is passed through the channels shown, which are various memory locations, ports, and other means of connection within the computer. These are shown interconnecting block 181 and 182. Block 181 is the application itself, and block 182 is the firmware/hardware that it is connecting to. Use of channels is the preferred method for this present invention, but is not required.

1. Regulated use of encrypted freely distributed files and streams by a user comprising the method steps of:
loading self-installing complex node on user's target computer;
installing said complex node on said user's target computer;
using said encrypted files and streams through secure local decryption by means of said installed node and by means of encrypted credit objects and encrypted policy objects;

2. A method of loading said self-installing node of claim 1 on user's target computer from data media such as floppy diskette or CD.

3. A method of loading said self-installing node of claim 1 on user's target computer from a network connection.

4. A method requiring said self-installing node of claim 1 to obtain a network connection to a node originator to install said node upon said target computer in a unique and complex fashion.

5. A method for claim 4 of providing sufficient complexity and variety in said node installation so as to make unauthorized access of any particular data stored by said node practically impossible.

6. A method for partially decrypting said encrypted files and streams of claim 1 by the node using the secret key associated with the particular file or stream;

7. A method for sending partially decrypted data between said node of claim 1 and the application which uses the decrypted file or stream through channels, which are one or more memory and other exchange locations in the target computer;

8. A method for claim 7 of partial decryption within said node using associated secret key and channels, such that said channel communications are initiated with preset channels between said node and said application, and a generated random number is passed over said channels, and used thereafter to determine channel sequences throughout data transmission from the node to the application;

9. A method of updating said node of claim 1 at intervals of time via network connection to provide improvement of security by changing node characteristics such as any of the following: said node secret key, encryption algorithm, channel patterns, unique identification, or calibration of time;

10. A method for sending and receiving data through channels described in claim 9 for any data exchange which requires security on the local computer;

11. A method of determining policy from said encrypted policy objects and their respective public keys in claim 1;

12. A method of receiving and loading said encrypted policy objects and said public keys in claim 11 onto said user's target computer by network connection from a security object source;

13. A method of updating said policy object in claim 12 at intervals of time via network connection to keep loaded policy objects current;

14. A method of determining credit from said encrypted credit objects and said encrypted secret keys in claim 1;

15. A method of receiving and loading said encrypted credit objects and said encrypted secret keys in claim 14 onto said user's target computer by network connection from a security object source;

16. A method for decrypting said encrypted secret keys in claim 15 with the target node's secret key;

17. A method for securely storing said encrypted credit objects and said decrypted secret keys in claim 17 as distributed throughout the target node's complex memory locations;

18. A method for regenerating the node in claim 4 locally through network connection to the node originator. Node modifications are transmitted over the network and stored on the local computer;

19. A method of generating said self-installing complex node in claim 1 by a node source comprising the steps of:
creating a unique node installation for a computer or digital equipment; the node is of such complexity and uniqueness as to require an installation program;
generating a unique installation program to install said unique node;

20. A method of generating said encrypted files and streams in claim 1 by a file or stream source comprising the steps of:
generating the encrypted files and streams and their identification headers that are associated with encrypted policy objects. Encryption of files and streams may be partial, intermittent or complete;
generating the secret public keys used to decrypt the files and streams;

21. A method of generating application which makes use of said node in claim 1 and said channel jumping in claim 7 by an application source:

22. A method of generating said security objects in claim 1 by a security object source comprising the steps of:
generating the public keys used to decrypt the policy objects;
generating encrypted policy objects with public keys. The policy objects are associated with a file or stream;
generating encrypted credit objects with or without encrypted secret keys that are associated with either individual or groups of files and or streams;
